(19) United States
(12) Patent Application Publication
(10) Pub. No.: US 2009/0052953 A1
(43) Pub. Date: Feb. 26, 2009

(54) IMAGE FORMING APPARATUS

(75) Inventor: Kouichi ETOU, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/193,559

(22) Filed: Aug. 18, 2008

(30) Foreign Application Priority Data
Aug. 23, 2007 (JP) 2007-217115

(51) Int. Cl. G03G 15/22

(52) U.S. Cl. 399/306

(57) ABSTRACT

An image forming apparatus which has means for permitting transfer members to be impressed with respective optimal transfer voltages without increasing the manufacturing cost. In the image forming apparatus, a transfer belt is driven to rotate, and a plural number of photosensitive drums, which bear toner images, are arranged side by side in the rotating direction of the transfer belt. A plural number of transfer members are located opposite from the respective photosensitive drums via the transfer belt. The transfer members charge the transfer belt with a polarity opposite to the polarity of the toner. The gap in the rotating direction of the transfer belt between the photosensitive drum and the transfer member in the most upstream transfer section is the largest, and the gap in the rotating direction of the transfer belt between the photosensitive drum and the transfer member in the most downstream transfer section is the smallest.

This application is based on Japanese application No. 2007-217115 filed on Aug. 23, 2007, the content of which is hereby incorporated by reference.

### BACKGROUND OF THE INVENTION

1. Field of the Invention

The present invention relates to an image forming apparatus, and more particularly to an image forming apparatus for forming color toner images by electrophotographic method.

2. Description of Related Art

FIG. 11 shows an essential part of a typical color image forming apparatus. The image forming apparatus is of a tandem type and transfers color toner images by a direct transfer method. Specifically, the image forming apparatus comprises a transfer belt 101, a driving roller 102, a driven roller 103, a suction roller 104, image forming units 110Y, 110M, 110C and 110K, and transfer members 115Y, 115M 115C and 115K. The image forming units 110Y, 110M, 110C and 110K comprise photosensitive drums 111Y, 111M, 111C and 111K, respectively. Operation of the image forming apparatus is described below. In the following paragraphs, the individual image forming units 110 are denoted by the reference symbols “110Y”, “110M”, “110C” and “110K” respectively, while the image forming units 110Y, 110M, 110C and 110K are generally denoted by only the reference number “110”. Concerning the photosensitive drums 111 and the transfer members 115, the same way of denotation is adopted.

In the image forming apparatus shown by FIG. 11, transfer medium S such as paper is fed sheet by sheet in a direction shown by arrow “B”. A sheet of transfer medium S passes between the driven roller 103 and the suction roller 104 and is sucked on the transfer belt 101 by static electricity. The transfer belt 101 is laid between the driving roller 102 and the driven roller 103 and is driven by the driving roller 102 to rotate in a direction shown by arrow “A”. With the rotation of the transfer belt 101, the transfer medium S passes through respective nip portions N between the photosensitive drums 111 and the transfer belt 101.

On the circumferential surfaces of the photosensitive drums 111Y, 111M, 111C and 111K, toner images of Y, M, C and K are formed. A specified transfer voltage is applied to the transfer members 115 from a high-voltage source (not shown).

When the transfer medium S passes through the respective nip portions N, the transfer members 115 charge the transfer medium S with a polarity opposite to the polarity of the toner. Thereby, the toner images of Y, M, C and K are transferred from the photosensitive drums 111Y, 111M, 111C and 111K sequentially to the transfer medium S and are combined on the transfer medium S. In this way, color toner images are transferred onto a sheet of transfer medium S.

In the image forming apparatus shown by FIG. 11, a transfer member 115 located more downstream in the transfer belt rotating direction “A” needs to be impressed with a higher voltage as the optimal transfer voltage than another transfer member 115 located more upstream. In other words, the optimal transfer voltages to be impressed on the individual transfer members 115 are different from each other. The “optimal transfer voltage” means the voltage impressed on the transfer member 115 which results in the most efficient image transfer from the photosensitive drum 111 onto the transfer medium S. The following is the reason why the optimal transfer voltages impressed on the individual transfer members 115 are different from each other.

The image forming apparatus shown by FIG. 11 performs four times of image transfer and thereby transfers color toner images onto a sheet of transfer medium S. In such a case wherein image transfer is performed a plural number of times, a downstream-positioned image forming unit 110 (for example, the image forming unit 110K) needs to transfer a toner image onto the transfer medium S while the transfer belt 101 and the transfer medium S have been already charged. Further, at that time, the transfer medium S has already obtained an image transferred thereon. In order to perform good image transfer from such a downstream-positioned image forming unit 110, therefore, a downstream-positioned transfer member 115 (for example, the transfer member 115K) needs to be impressed with a higher transfer voltage than an upstream-positioned transfer member 115 (for example, the transfer member 115Y).

JP2001-255761A discloses that in an image forming apparatus, three Zener diodes are connected to a constant-voltage power source. One of the four transfer members is connected directly to the constant-voltage power source. The other three transfer members are connected to the constant-voltage power source via one, two and three Zener diodes, respectively, which are serially connected in-between. In the structure, because of Zener effect of the Zener diodes, the single constant-voltage power source can impress the four transfer members with transfer voltages respectively optimal to the four transfer members.

However, since the image forming apparatus disclosed by JP2001-255761A requires Zener diodes, the manufacturing cost of the apparatus is high. JP6-110343A and JP9-50197 disclose image forming apparatuses with means for permitting transfer members to be impressed with respective optimal transfer voltages. However, none of these publications discloses any solutions of the problem of high manufacturing cost.

### SUMMARY OF THE INVENTION

An object of the present invention is to provide an image forming apparatus which has a means for permitting transfer members to be impressed with respective optimal transfer voltages without increasing the manufacturing cost.

An image forming apparatus according to the present invention comprises: a transfer belt which is driven to rotate; a plural number of photosensitive drums which are arranged side by side in a rotating direction of the transfer belt to face the transfer belt, each of the photosensitive drums bearing an image of toner thereon; and a plural number of transfer members which are located opposite from the photosensitive drums via the transfer belt to make pairs with the respective opposite photosensitive drums, the transfer members charging the transfer belt with a polarity opposite to that of the toner. In the image forming apparatus, in the pairs, the pair of the photosensitive drum and the transfer member which is located most upstream in the rotating direction of the transfer belt has a largest gap in the rotating direction of the transfer belt between the photosensitive drum and the transfer member, and the pair of the photosensitive drum and the transfer member which is located most downstream in the rotating direction of the transfer belt has a smallest gap in the rotating direction of the transfer belt between the photosensitive drum and the transfer member.

According to the present invention, the transfer members may be located downstream from the respective opposite photosensitive drums.

In the image forming apparatus according to the present invention, a pair located more downstream in the rotating direction of the transfer belt may have a smaller gap in the rotating direction of the transfer belt between the photosensitive drum and the transfer member than a pair located more upstream in the rotating direction of the transfer belt.

The inventive image forming apparatus may further comprise a power source for impressing a voltage on the transfer members, the power source being, in number, at least one and less than the number of the transfer members.

In the inventive image forming apparatus, the transfer belt may have a sucking surface for sucking and holding transfer medium thereon, the sucking surface being a surface facing the photosensitive drums, and the transfer members transfer the toner images onto the transfer medium by charging the transfer medium via the transfer belt.

In the inventive image forming apparatus, the toner images may be transferred onto the transfer belt.

In the inventive image forming apparatus, in a state in which gaps in the rotating direction of the transfer belt between the photosensitive drums and the transfer members in the respective pairs are equal to one another, voltages impressed on the individual transfer members which result in minimum amounts of residual toner on the respective photosensitive drums after image transfer may be found out, and the gaps in the rotating direction of the transfer belt between the photosensitive drums and the transfer members in the respective pairs may be designed such that the higher the voltage impressed on the transfer member which results in a minimum amount of residual toner on the opposite photosensitive drum is, the smaller the gap between the photosensitive drum and the transfer member is.

In the inventive image forming apparatus, in a state in which gaps in the rotating direction of the transfer belt between the photosensitive drums and the transfer members are equal to one another, ranges of voltages impressed on the individual transfer members which result in residual toner not more than a specified amount on the respective photosensitive drums after transfer may be found out, and the gaps in the rotating direction of the transfer belt between the photosensitive drums and the transfer members in the respective pairs may be designed such that the higher the range of voltages impressed on the transfer member which results in residual toner not more than the specified amount on the photosensitive drum is, the smaller the gap between the photosensitive drum and the transfer member is.

### BRIEF DESCRIPTION OF THE DRAWINGS

This and other objects and features of the present invention will be apparent from the following description with reference to the accompanying drawings, in which:

FIG. 1 is a schematic illustration of an image forming apparatus according to the present invention, showing the general structure;

FIG. 2 is a schematic illustration of an essential part of the image forming apparatus;

FIG. 3 is a plan view of a first exemplary transfer member;

FIG. 4 is a sectional view of a second exemplary transfer member:

FIG. 5 is a sectional view of a third exemplary transfer member;

FIG. 6 is a schematic illustration of an essential part of the image forming apparatus comprising fourth exemplary transfer members;

FIG. 7 is a schematic illustration showing the positional relationship between photosensitive drums and transfer members;

FIGS. 8a, 8b, 8c and 8d are graphs showing the relationship between transfer efficiency and transfer voltage in a conventional image forming apparatus;

FIGS. 9a, 9b, 9c and 9d are graphs showing the relationship between transfer efficiency and transfer voltage in the image forming apparatus according to the present invention;

FIG. 10 is a graph showing the relationship between the amount of residual toner and color difference A E; and

FIG. 11 is a schematic illustration of an essential part of a conventional image forming apparatus.

### DETAILED DESCRIPTION OF THE PREFERRED EMBODIMENTS

### Structure of the Image Forming Apparatus

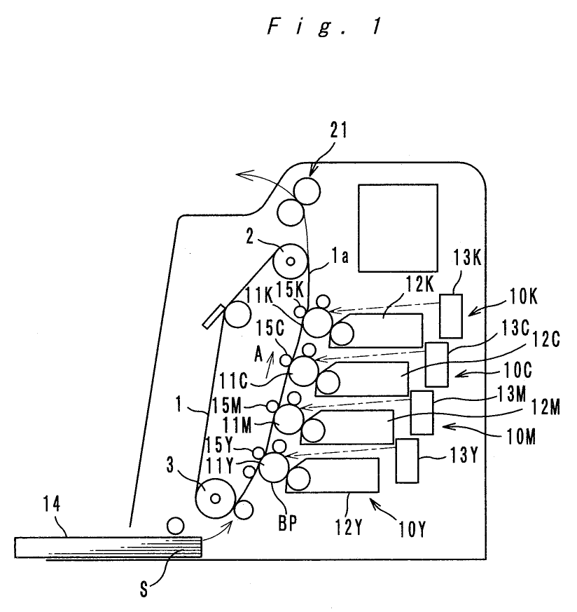

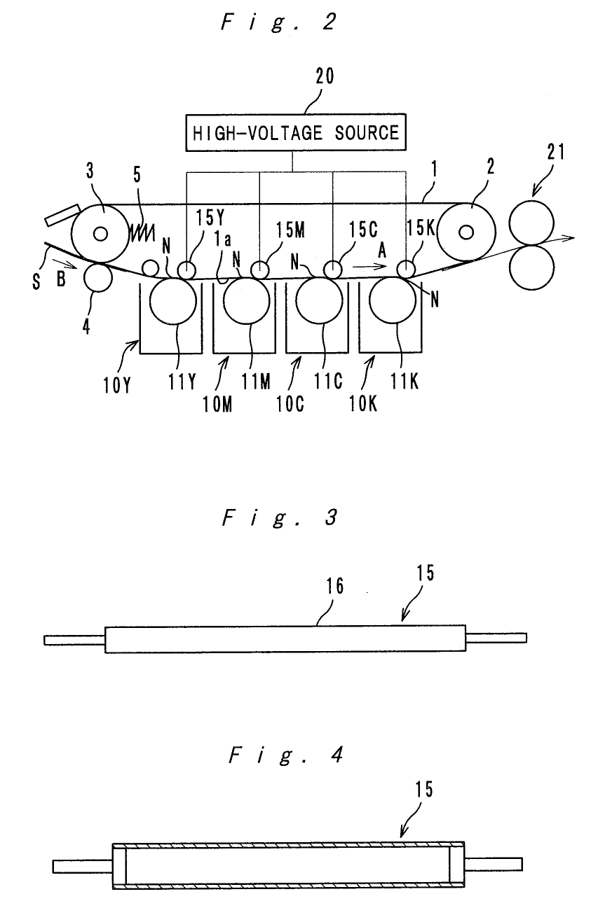

An image forming apparatus according to an embodiment of the present invention is described with reference to FIGS. 1 and 2. FIG. 1 shows the general structure of the image forming apparatus according to the embodiment. The image forming apparatus shown by FIG. 1 is an electrophotographic color printer of a tandem type, and the color printer transfers and combines images of four colors (Y: yellow, M: magenta, C: cyan and K: black) by a direct transfer method. The image forming apparatus comprises, as shown by FIG. 1, a transfer belt 1, a driving roller 2, a driven roller 3, image forming units 10Y, 10M, 10C and 10K, a cassette 14, transfer members 15Y, 15M, 15C and 15K, and a fixing unit 21. The image forming units 10Y, 10M, 10C and 10K comprise photosensitive drums 11Y, 11M 11C and 11K, developing devices 12Y, 12M, 12C and 12K, and laser scanning devices 13Y, 13M, 13C and 13K, respectively.

FIG. 2 shows an essential part of the image forming apparatus. The part shown by FIG. 2 is a structure for transfer of toner images. Specifically, the structure comprises a transfer belt 1, the driving roller 2, the driven roller 3, a suction roller 4, a coil spring 5, the image forming units 10Y, 10M, 10C and 10K, the photosensitive drums 11Y, 11M, 11C and 11K, the transfer members 15Y, 15M, 15C and 15K, a high-voltage source 20 and the fixing unit 21. In the following paragraphs, the individual image forming units 10 are denoted by the reference symbols “10Y”, “10M”, “10C” and “10K”, while the image forming units 10Y, 10M, 10C and 10K are generally denoted by only the reference number “10”. Concerning the photosensitive drums 11, the developing devices 12, the laser scanning devices 13 and the transfer members 15, the same way of denotation is adopted.

The image forming units 10Y, 10M, 10C and 10K form toner images of Y, M, C and K on the circumferential surfaces of the photosensitive drums 111Y, 111M, 111C and 111K, respectively, in the following process. The photosensitive drums 11 are arranged side by side in a rotating direction of the transfer belt 1 and face the transfer belt 1. Thereby, as shown by FIG. 2, nip portions N are formed between the respective photosensitive drums 11 and the transfer belt 1. The surfaces of the photosensitive drums 11 are charged with a negative polarity by a charger (not shown). The laser scanning devices 13 are controlled by a control section (not shown) to irradiate the respective photosensitive drums 11 with laser beams in accordance with image data of Y. M, C and K. Thereby, electrostatic latent images are formed on the surfaces of the photosensitive drums 11.

Each of the developing devices 12 contains a two-component developer composed of toner and carrier and has a developing roller. The developing roller supplies the toner, which was charged to a negative polarity in the developing device 12, to the corresponding photosensitive drum 11, and thereby, a toner image is formed on the surface of the photosensitive drum 11. Thus, the photosensitive drum 11 bears a toner image on its surface. The developer needs not be a two-component developer and may be a one-component developer.

The cassette 14 feeds transfer medium S, such as paper, sheet by sheet. The transfer belt 1 is wound around and is laid between the driving roller 2 and the driven roller 3 endlessly. As shown by FIG. 2, the transfer belt 1 is driven by the driving roller 2 to rotate in a direction shown by arrow “A” at a constant speed. The principal component of the transfer belt 1 is polycarbonate, polyimide, polyvinylidene fluoride, polybutylene terephthalate or the like, and the thickness of the transfer belt 1 is within a range from 80 μm to 150 μm. The surface resistivity of the transfer belt 1 is within a range from 1.0×10⁸ Ω/□ to 1.0×10¹² Ω/□, and the volume resistivity of the transfer belt 1 is within a range from 1.0×10⁸ Ω·cm to 1.0×10¹² Ω·cm. The transfer belt 1 does not need to have these properties.

As shown by FIG. 2, the transfer medium S is fed sheet by sheet in a direction shown by arrow “B”. Then, the transfer medium S is sucked on the surface of the transfer belt 1 facing the photosensitive drums 11 (hereinafter referred to as a sucking/feeding surface la) by static electricity applied from the suction roller 4 and fed in the direction “A”. The driven roller 3 is pushed by the coil spring 5 elastically, and thereby, the transfer belt 1 keeps constant tensile force.

The transfer members 15 are arranged side by side and located opposite from the photosensitive drums 11 via the transfer belt 1. Specifically, the transfer members 15 are located inside the ring of the transfer belt 1, near the nip portions N and are pressed against the transfer belt 1 onto the side reverse the sucking/feeding surface la. The transfer members 15 are made of a conductive material and are of a structure described below. The transfer members 15 are positioned downstream in the rotating direction of the transfer belt 1 (direction “A”) from the respective photosensitive drums 11. The positions of the transfer members 15 will be described in more detail later.

Only one high-voltage source 20 is provided for the transfer members 15, and the high-voltage source 20 impresses a specified voltage on the transfer members 15. By the voltage impression of the high-voltage source 20, the transfer members 15 are charged with a polarity opposite to the polarity of the toner, that is, are charged with a positive polarity. Accordingly, the transfer medium S sucked and fed on the sucking/feeding surface la of the transfer belt 1 is charged with the polarity opposite to the polarity of the toner (to a positive polarity) by the transfer members 15 via the transfer belt 1, and thereby, the toner images formed on the photosensitive drums 11 are transferred onto the transfer medium S.

The above-described transfer process is executed at the nip portions N to transfer a Y toner image, an M toner image, a C toner image and K toner image sequentially, and the toner images are combined on the transfer medium S. Then, the fixing unit 21 fixes the toner images on the transfer medium S by executing a heating treatment and a pressing treatment toward the transfer medium S.

The transfer members 15 are made of a conductive material and may be, for example, metal rollers as described below. Specific Examples of the Transfer Members

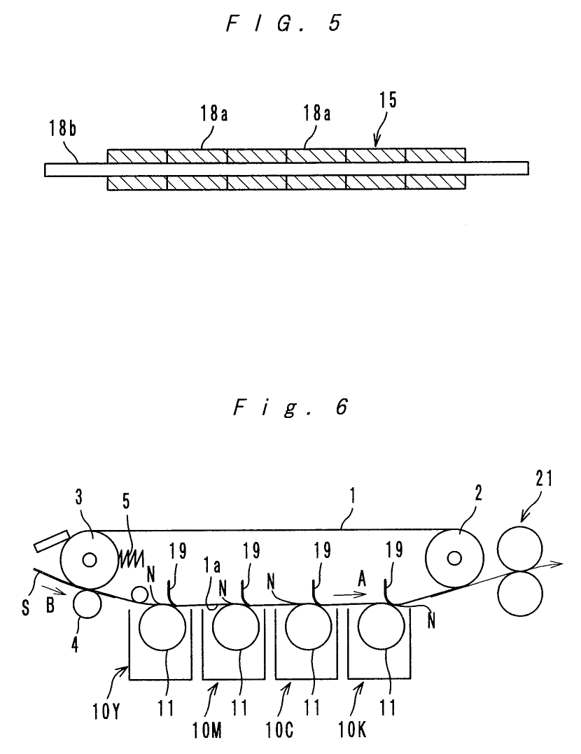

FIG. 3 shows a first example of the transfer members 15. The first example is a metal shaft 16 serving as a transfer roller. The metal is preferably iron with a nickel plating, stainless steel, aluminum, etc. FIG. 4 shows a second example of the transfer members 15. The second example is a metal hollow pipe and accordingly is light.

FIG. 5 shows a third example of the transfer members 15. The third example is a roller composed of a plural number of conductive resin sleeves 18a made of, for example, conductive polyacetal covered on a metal shaft 18b.

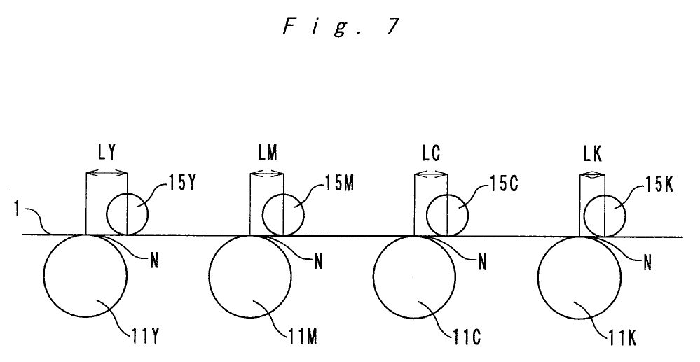

FIG. 6 shows a fourth example of the transfer members 15. The fourth example is a conductive film 19 made of fluorine contained resin, polyamide contained resin or the like with a surface resistivity of approximately 100 Ω.

### Locations of the Transfer Members

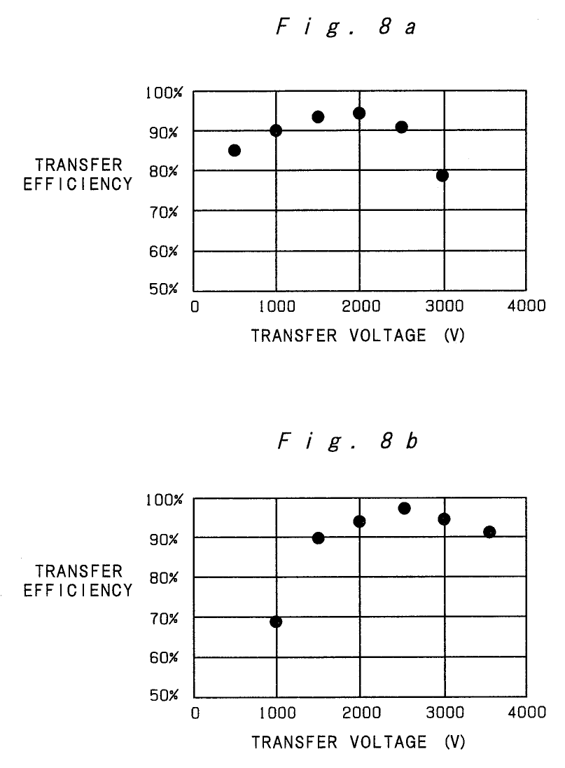

Next, referring to FIG. 7, the locations of the transfer members 15 are described. FIG. 7 shows the positional relationship between the photosensitive drums 11 and the transfer members 15. Although the transfer belt 1 actually bends along the circumferential surfaces of the photosensitive drums 11 and the transfer members 15, the bending of the transfer belt 1 is not shown in FIG. 7.

The transfer members 15 are, as mentioned, made of a conductive material and accordingly have small electric resistance. Therefore, in order to form electric fields for transfer of toner images, it is necessary to use the electric resistance of the transfer belt 1. Specifically, in each transfer section (including the photosensitive drum 11 and the transfer member 15), a gap is formed between the photosensitive drum 11 and the transfer member 15, and more specifically, the transfer member 15 is located 2 mm to 6 mm downstream in the belt rotating direction from the opposite photosensitive drum 11. Thereby, the electric resistance of the transfer belt 1 in proportion to the gap between the photosensitive drum 11 and the transfer member 15 is used to form an electric field.

Conventionally, as shown in FIG. 11, the gaps between the transfer members 115 and the respectively opposite photosensitive drums 111 in the rotating direction of the transfer belt 101 are a fixed value L. Accordingly, the values of the electric resistance of the transfer belt 1 used to form electric fields for transfer of toner images from the respective photosensitive drums 111 are equal to one another. However, as described above, a downstream-positioned image forming unit 110 needs to transfer a toner image onto the transfer medium S which has already obtained transferred toner images while the transfer belt 101 and the transfer medium S have been already charged. Therefore, the optimal transfer voltage to be impressed on a downstream-positioned transfer member 115 is higher than the optimal transfer voltage impressed on an upstream-positioned transfer member 115. For example, according to an experiment conducted by the inventors, the optimal transfer voltages to be impressed on the transfer members 115Y, 115M, 115C and 115K were 2000V, 2500V, 2500V and 3000V, respectively.

In the image forming apparatus according to the embodiment, as shown by FIG. 7, the gaps LY, LM, LC and LK between the photosensitive drums 11 and the respectively opposite transfer members 15 in the rotating direction of the transfer belt 1 are designed as follows. The gap LY between the photosensitive drum 1lY and the transfer member 15Y in the most upstream transfer section is the largest, and the gap LK between the photosensitive drum 11K and the transfer member 15K in the most downstream transfer section is the smallest. The gaps LM and LC are equal to each other.

Since the transfer members 15 are located as shown in FIG. 7, the electric resistance between the photosensitive drum 11Y and the transfer member 15Y is relatively large, and the electric resistance between the photosensitive drum 11K and the transfer member 15K is relatively small. Thereby, the optimal transfer voltage to be impressed on the transfer member 15Y can be higher than the optimal voltage to be impressed on the transfer member 115Y in the conventional image forming apparatus, and the optimal transfer voltage to be impressed on the transfer member 15K can be lower than the optimal voltage to be impressed on the transfer member 115K in the conventional image forming apparatus. Consequently, the optimal transfer voltages to be impressed on the transfer members 15Y, 15M, 15C and 15K can be equal to one another. According to an experiment conducted by the inventors as described below, when the gaps LY, LM, LC and LK were 5 mm, 4 mm, 4 mm and 3 mm respectively, a constant voltage could be impressed on all the transfer members 15 as respective optimal transfer voltages. Thus, without using any additional components such as Zener diodes, the transfer voltages to be impressed on the individual transfer members 15 can be regulated to optimal values.

### Experiment

In order to make the best use of the present invention, the inventors conducted an experiment. In the experiment, the image forming apparatus according to the embodiment shown by FIG. 2 and the conventional image forming apparatus shown by FIG. 11 were used, and while varying the transfer voltage impressed on each of the transfer members 15 and 115, the transfer efficiency from each of the photosensitive drums 11 and 111 to transfer medium S was examined. The experiment was conducted under the following conditions.

temperature: 23° C.

humidity: 65%

rotation speed of the transfer belt: 150 mm/s

density of toner adhering to a solid patch (denoted by “BP” in FIG. 1) on the photosensitive drum: 6 g/m²

surface resistivity of the transfer belt (average): 5.0×10¹⁰ Ω/□

volume resistivity of the transfer belt (average): 5.0×10⁸ Ω·cm

length of each nip portion in the belt rotating direction: 1 mm to 2 mm

transfer medium: ordinary paper with a weight of 80 g/m²

gap L: 4 mm

gap LY: 5 mm

gap: LM: 4 mm

gap LC: 4 mm

gap LK: 3 mm

transfer voltage: changing within a range from 500V to 4000V by increasing by 500V at one step (Voltages of 500V, 3500V and 4000V were not applied to some of the transfer members.)

In the experiment, the transfer efficiency was measured in the following method. The following description of the measuring method will be made in connection with the image forming apparatus according to the embodiment shown by FIGS. 1 and 2. However, the same measuring method was adopted to measure the transfer efficiency in the conventional image forming apparatus shown by FIG. 11. The experiment to find out the relationship between the transfer efficiency and the transfer voltage was conducted on every transfer member, and the transfer efficiency was measured as described below every after application of a transfer voltage.

First, a toner image of a solid pattern was formed on the photosensitive drum 11 by use of the developing device 12. Next, the density of toner on the solid pattern before transfer was measured by a suction method. The toner density measured at this stage is referred to as “measured value 1”. The suction method is to suck toner in a specified area (50 mm×10 mm) with a suction nozzle and to calculate the density of toner by dividing the weight of the sucked toner by the area.

Then, the density of toner transferred onto the transfer medium S was measured by the suction method. The density of toner measured at this stage is referred to as “measured value 2”. The suction method was described above. Finally, the transfer efficiency was obtained by dividing the measured value 2 by the measured value 1 and by multiplying the division with 100.

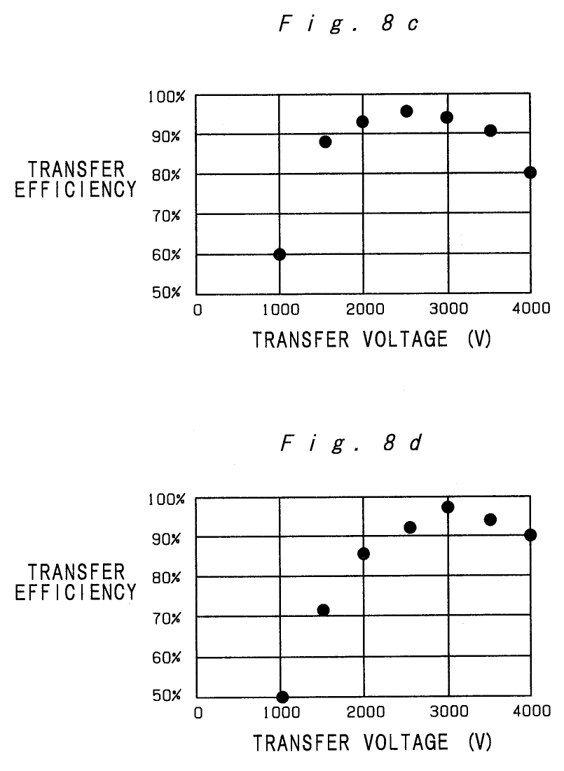

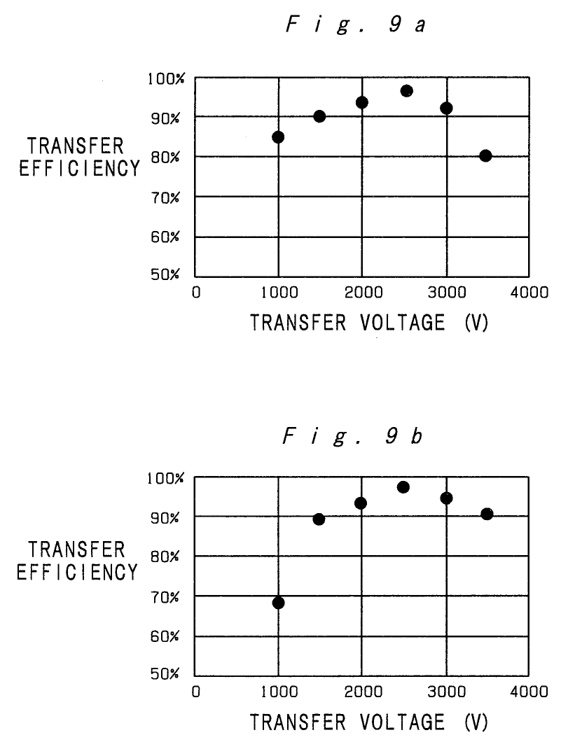

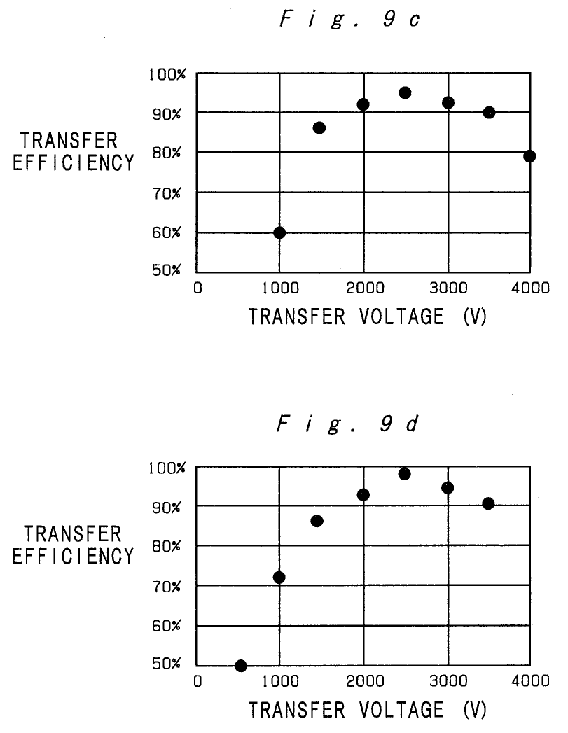

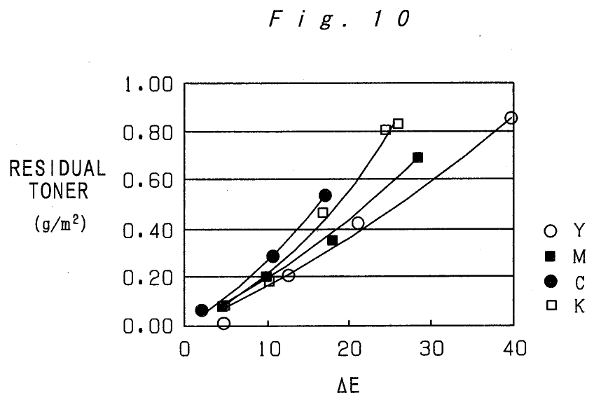

FIGS. 8a to 9d show the results of the experiment which was conducted under the conditions and by the method described above. FIGS. 8a, 8b, 8c and 8d show the relationship between the transfer efficiency and the transfer voltage in the image forming apparatus shown by FIG. 11. FIG. 8a is a graph in connection with the transfer member 115Y, and FIG. 8b is a graph in connection with the transfer member 115M. FIG. 8c is a graph in connection with the transfer member 115C, and FIG. 8d is a graph in connection with the transfer member 115K. FIGS. 9a, 9b, 9c and 9d show the relationship between the transfer efficiency and the transfer voltage in the image forming apparatus shown by FIGS. 1 and 2. FIG. 9a is a graph in connection with the transfer member 15Y, and FIG. 9b is a graph in connection with the transfer member 15M. FIG. 9c is a graph in connection with the transfer member 15C, and FIG. 9d is a graph in connection with the transfer member 15K. In the graphs, the y axis shows the transfer efficiency, and the x axis shows the transfer voltage.

In the conventional image forming apparatus shown by FIG. 11, as FIG. 8a shows, when a transfer voltage of 2000V was impressed on the transfer member 115Y, the transfer efficiency of the transfer member 115Y was the highest. As FIG. 8b shows, when a transfer voltage of 2500V was impressed on the transfer member 115M, the transfer efficiency of the transfer member 115M was the highest. As FIG. 8c shows, when a transfer voltage of 2500V was impressed on the transfer member 115C, the transfer efficiency of the transfer member 115C was the highest. As FIG. 8d shows, when a transfer voltage of 3000V was impressed on the transfer member 115K, the transfer efficiency of the transfer member 115K was the highest. As is apparent from the results, when the gaps L are equal to one another, the optimal transfer voltages to be impressed on the 115Y, 115M, 115C and 115K are different.

According to the embodiment, on the other hand, in the image forming apparatus shown by FIGS. 1 and 2, as FIGS. 9a to 9d show, concerning all the transfer members 15Y, 15M, 15C and 15K, when a transfer voltage of 2500V was impressed, the transfer efficiency was the highest. As is apparent from the results, when the gaps LY, LM, LC and LK meet a condition of LY>LM=LC>LK, the optimal transfer voltages to be impressed on the transfer members 15Y, 15M, 15C and 15K are equal to one another. Thus, only by varying the gaps LY, LM, LC and LM, a constant voltage can be impressed on all the transfer members 15 as the respective optimal transfer voltages, and therefore, it is not necessary to use any additional components.

### Determination of the Gaps LY, LM, LC and LK

In the following, an exemplary way of determining the gaps LY, LM, LC and LM is described. The gaps LY, LM, LC and LM are determined by following a procedure below.

First, an image forming apparatus as shown by FIG. 11, in which the gaps L between the photosensitive drums 111 and the respective photosensitive members 115 are equal to one another, is prepared. In the image forming apparatus, image transfer is performed in each transfer section. At this stage, a plural number of different voltages are impressed as executed in the above-described experiment, and after each execution of transfer, the amount of residual toner on the photosensitive drum 111 is measured.

Now, a way of measuring the residual toner is described. The measurement of the residual toner is performed in the following process. After image transfer, residual toner on the photosensitive drum 111 is removed with a transparent tape. Next, the transparent tape is stuck on white paper, on which another transparent tape with no toner thereon was stuck beforehand. Then, the transparent tape with toner thereon is compared with the transparent tape with no toner thereon. Specifically, the color difference ΔE between these two tapes is measured.

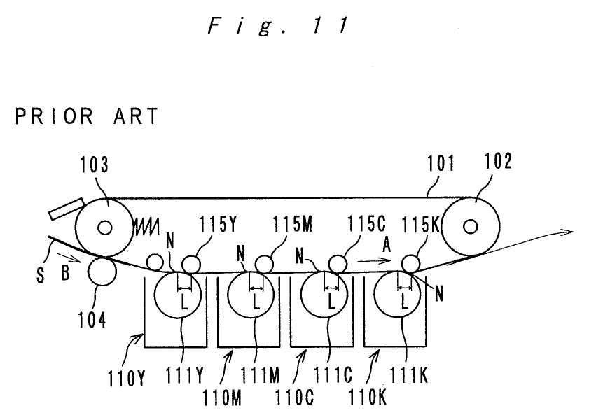

Concerning each color of Y, M, C and K, the relationship between the amount of residual toner (the amount of toner adhering to the transparent tape) and the color difference ΔE is known from experiments. FIG. 10 is a graph showing the relationship between the amount of residual toner of each color and the color difference A E. In the graph, the y axis shows the amount of residual toner, and the x axis shows the color difference ΔE. The curves in the graph are approximated to quadratic functions, and thus, functions defining the correlation between the amount of residual toner and the color difference ΔE in connection with the respective colors Y, M, C and K are obtained. By substituting the measured values ΔE in the functions, the amounts of residual toner of the respective colors are calculated.

The measurement of the amount of residual toner is performed on every photosensitive drum 111 and every after transfer of a toner image with a transfer voltage impressed on the opposite transfer member 115. Next, concerning transfer of an image of each color, the transfer voltage which resulted in the minimum amount of residual toner on the photosensitive drum 111 is found out. When impression of a relatively high transfer voltage on the transfer member 115 resulted in the minimum amount of residual toner on the photosensitive drum 111, the gap between the corresponding transfer member 15 and the corresponding photosensitive drum 11 in the image forming apparatus according to the embodiment is designed to be relatively short. When impression of a relatively low transfer voltage on the transfer member 115 resulted in the minimum amount of residual toner, the gap between the corresponding transfer member 15 and the corresponding photosensitive drum 11 in the image forming apparatus according to the embodiment is designed to be relatively long.

It is not always necessary to determine the gap between the photosensitive drum 11 and the transfer member 15 in each transfer section based on the transfer voltage which resulted in the minimum amount of residual toner. The determination may be made based on a range of transfer voltages impressed on the transfer member 115 which resulted in residual toner not more than a specified amount. In this case, when a range of relatively high transfer voltages resulted in residual toner not more than the specified amount, the gap between the corresponding transfer member 15 and the corresponding photosensitive drum 11 in the image forming apparatus according to the embodiment is designed to be relatively short. When a range of relatively low transfer voltages resulted in residual toner not more than the specified amount, the gap between the corresponding transfer member 15 and the corresponding photosensitive drum 11 in the image forming apparatus according to the embodiment is designed to be relatively large.

In the embodiment, in each transfer section, the gap between the photosensitive drum 11 and the transfer member 15 in the rotating direction of the transfer belt 1 means, for example, the distance between the center of the nip portion N and the center of the contact portion of the transfer member 15 with the transfer belt 1.

### Other Embodiments

An image forming apparatus according to the present invention is not limited to the embodiment above.

For example, the present invention is applicable to an image forming apparatus of an intermediate transfer type wherein toner images are transferred onto a transfer belt (first transfer) and thereafter transferred onto transfer medium (second transfer). More specifically, the present invention is applicable to a section for the first transfer. Also, the present invention is applicable not only to an image forming apparatus of a type wherein the sucking/feeding surface la of the transfer belt 1 faces sideways as shown by FIG. 1 but also an image forming apparatus of a type wherein the sucking/feeding surface la of the transfer belt 1 faces either up or down.

In the four transfer sections, a transfer section located more downstream in the rotating direction of the transfer belt 1 may have a smaller gap between the photosensitive drum 11 and the transfer member 15 than another transfer section located more upstream. The variation among the transfer sections in the gap between the photosensitive drum 11 and the transfer member 15 can be selected from the following seven options according to the transfer performances of the transfer sections.

(1) LK=LC=LM<LK

(2) LK=LC<LM<LY

(3) LK<LC=LM<LY

(4) LK<LC<LM<LY

(5) LK=LC<LM=LY

(6) LK<LC=LM=LY

(7) LK<LC<LM=LY

In the embodiment above, only one high-voltage source 20 is provided. However, two or more voltage sources 20 may be provided, as long as the number of voltage sources 20 is less than the number of transfer members 15.

The image forming apparatus according to the present invention can be adapted for a printer, a copying machine, a facsimile and a multi-function peripheral with these functions.

Although the present invention has been described in connection with the embodiment above, it is to be noted that various changes and modifications may be apparent to those who are skilled in the art. Such changes and modifications are to be understood as being within the scope of the present invention.

What is claimed is:

1. An image forming apparatus comprising:
a transfer belt which is driven to rotate;
a plural number of photosensitive drums which are arranged side by side in a rotating direction of the transfer belt to face the transfer belt, each of the photosensitive drums bearing an image of toner thereon; and
a plural number of transfer members which are located opposite from the photosensitive drums via the transfer belt to make pairs with the respective opposite photosensitive drums, the transfer members charging the transfer belt with a polarity opposite to that of the toner,
wherein in the pairs, the pair located most upstream in the rotating direction of the transfer belt has a largest gap in the rotating direction of the transfer belt between the photosensitive drum and the transfer member, and the pair located most downstream in the rotating direction of the transfer belt has a smallest gap in the rotating direction of the transfer belt between the photosensitive drum and the transfer member.

2. An image forming apparatus according to claim 1,
wherein the transfer members are located downstream from the respective opposite photosensitive drums in the rotating direction of the transfer member.

3. An image forming apparatus according to claim 1,
wherein a pair located more downstream in the rotating direction of the transfer belt has a smaller gap in the rotating direction of the transfer belt between the photosensitive drum and the transfer member than a pair located more upstream in the rotating direction of the transfer belt.

4. An image forming apparatus according to claim 1, further comprising:
a power source for impressing a voltage on the transfer members, the power source being, in number, at least one and less than the number of the transfer members.

5. An image forming apparatus according to claim 1,
wherein the transfer belt has a sucking surface for sucking and holding transfer medium thereon, the sucking surface being a surface facing the photosensitive drums; and
wherein the transfer members transfer the toner images onto the transfer medium by charging the transfer medium via the transfer belt.

6. An image forming apparatus according to claim 1,
wherein the images of toner are transferred onto the transfer belt.

7. An image forming apparatus according to claim 1,
wherein in a state in which gaps in the rotating direction of the transfer belt between the photosensitive drums and the transfer members in the respective pairs are equal to one another, voltages impressed on the individual transfer members which result in minimum amounts of residual toner on the respective photosensitive drums after image transfer are found out, and the gaps in the rotating direction of the transfer belt between the photosensitive drums and the transfer members in the respective pairs are designed such that the higher the voltage impressed on the transfer member which results in a minimum amount of residual toner on the opposite photosensitive drum is, the smaller the gap between the photosensitive drum and the transfer member is.

8. An image forming apparatus according to claim 1,
wherein in a state in which gaps in the rotating direction of the transfer belt between the photosensitive drums and the transfer members in the respective pairs are equal to one another, ranges of voltages impressed on the individual transfer members which result in residual toner not more than a specified amount on the respective photosensitive drums after transfer are found out, and the gaps in the rotating direction of the transfer belt between the photosensitive drums and the transfer members in the respective pairs are designed such that the higher the range of voltages impressed on the transfer member which results in residual toner not more than the specified amount on the photosensitive drum is, the smaller the gap between the photosensitive drum and the transfer member is.
